(19) United States
(12) Patent Application Publication
(10) Pub. No.: US 2024/0141960 A1
(43) Pub. Date: May 2, 2024

(54) PAD AND THRUST DEVICE ASSEMBLY, BRAKE CALIPER

(71) Applicant: Brembo S.p.A., Curno (IT)

(72) Inventors: Davide D'ALESSIO, Curno (IT); Andrea MECOCCI, Curno (IT); Andrea TERUZZI, Curno (IT); Cristian CRIPPA, Curno (IT)

(21) Appl. No.: 18/494,182

(22) Filed: Oct. 25, 2023

(30) Foreign Application Priority Data
Oct. 27, 2022 (IT) 102022000022167

(51) Int. Cl. F16D 65/097; F16D 65/18

(52) U.S. Cl. CPC F16D 65/0971; F16D 65/18

(57) ABSTRACT

A brake pad and thrust device assembly for a brake caliper may have at least one brake pad and at least one thrust device, where each thrust device is reversibly connectable to the brake pad.

### FIELD

The present invention relates to a pad and thrust device assembly for a brake caliper, as well as to a brake caliper.

### BACKGROUND

Brake pad and thrust device assemblies for brake calipers comprising at least one brake pad and at least one thrust device, which are reversibly connectable to each other, are known. In these brake pad and thrust device assemblies of known type, a retaining mechanism is provided between the brake pad and the respective thrust device, which keeps the thrust device engaged with the brake pad. Usually, the brake pad comprises a support plate supporting a friction material. The thrust device is adapted to apply a thrust action to the back of the plate, which is opposite to the friction material. The thrust device comprises a thrust device body having a side wall which internally delimits a thrust device cavity open towards the brake pad. With the thrust device and the brake pad assembled in conditions of use, the connection between the thrust device and the brake pad allows retracting the brake pad by moving it away from the braking surface of the brake disc as soon as the thrust device retracts into its seat made in the caliper body.

For example, document DE19906804 discloses a brake pad and a thrust device which are reversibly connectable by means of a wire spring constrained to the back of the plate by means of specific coupling rings, where the wire spring holds the thrust device by applying a restraining action to an annular groove made on the outer side wall of the thrust device. Although this assembly allows a reversible connection between the thrust device and the brake pad, the connection of the wire spring into the appropriate seats and the connection between the thrust device and the wire spring is poorly intuitive and very time-consuming during the assembly, and requires special tools to connect and decouple the thrust device and the brake pad.

Other solutions are known from documents DE4240872, DE19858743, US2020232528 and DE19652933, where the brake pad is reversibly connectable to the thrust device by means of a band spring comprising tabs bent and constrained to the back of the plate to be inserted by interference into the piston cavity.

Despite these solutions allowing for a reversible connection between the thrust device and the brake pad, during assembly, the bent tabs of the band spring may be subjected to accidental shocks and stresses, which can cause plastic deformations that compromise the seal and reliability of the connection between the brake pad and the piston. Additionally, these band spring solutions are not very versatile, since they are not adapted to be used in small pistons or thrust devices.

Still other solutions in which the thrust device and the brake pad are reversibly connectable are known from document EP1957821, where there is a pin protruding in a cantilevered manner from the back of the pad and adapted to engage a wire spring having a V-shaped central bend, where the wire spring is housed in the piston cavity, where the V-shaped central bend is bent away from the pad plate so as to bias the piston against the pad when the pin is engaged in the V-shaped central bend.

This solution, although allowing a reversible connection between the brake pad and the piston, requires a great deal of attention for the orientation of the V-shaped or U-shaped central bend during the assembly to allow the pin to be correctly inserted into the central bend in the radially inner portion thereof by engaging it with the pin, and then lifting the brake pad in the radial direction towards the V-shaped bend to tighten the brake pad against the piston by virtue of the elastic action of the V-shaped bend, making the assembly complex and time-consuming.

Therefore, a need felt in the industry is to manufacture brake pad and thrust device assemblies, which allow a reversible connection between the brake pad and thrust device which is easy, effective, and intuitive reducing the time required for assembly, maintaining high connection reliability over time, and allowing an integral retraction of the brake pad and piston while avoiding any residual frictional torques between the brake pad and the brake disc once the braking action is complete.

### SUMMARY

It is an object of the present invention to provide a brake pad and thrust device assembly, as well as a brake caliper which allow smooth assembly and reliable connection between brake pad and thrust device.

This and other objects and advantages are achieved by a brake pad and thrust device assembly, a brake caliper, as well as a method for reversibly connecting a brake pad and a thrust device according to the claims.

Some advantageous embodiments are the subject of the dependent claims.

By virtue of the suggested solutions, it is possible to allow an axial connection between the thrust device and the brake pad, regardless of the orientation of the spring within the thrust device cavity.

Additionally, by virtue of the suggested solutions, it is possible to allow an axial connection between the thrust device and the brake pad, preventing any accidental impacts during assembly for an elastic element which connects the brake pad and the thrust device.

Additionally, by virtue of the geometries of the pad and thrust device assembly, it is possible to facilitate the assembly of the brake pad and thrust device by virtue of a self-centering coupling with a movement along a thrust direction.

### DESCRIPTION OF THE FIGURES

Further features and advantages of the pad and thrust device assembly and of the brake caliper will become apparent from the following description of preferred embodiments thereof, given by way of non-limiting indication, with reference to the accompanying figures, in which:

FIG. 1 is an axonometric view of a brake caliper according to the invention;

FIG. 2 is an axonometric view of a brake pad and thrust device assembly according to the present invention, in which at least one brake pad and each thrust device are in an assembled configuration;

FIG. 3 is an axonometric view of the brake pad and thrust device assembly in FIG. 2, in which a pair of brake pads, each thrust device, each pin, and each retention element can be seen in an exploded view;

FIG. 4 is a partially sectioned axonometric view of a brake pad and thrust device assembly according to the present invention in an assembled configuration, where the assembly comprises a brake pad and a thrust device, where by virtue of the partially sectioned thrust device, a pin protruding from the back of a brake pad support plate, a retention device, preferably a wire spring, constrained in an annular groove made by an inner surface of the thrust device facing a thrust device cavity can be seen, where the spring comprises a first retention arm and a second retention arm radially spaced apart from each other forming a coupling seat for the pin, where the first retention arm and the second retention arm are radially elastically movable being constantly biased in a resting configuration to clamp the pin, where the pin is shaped so as to facilitate, with a first tapered portion thereof, which is distal with respect to the support plate, the insertion of the pin between the first retention arm and the second retention arm and so as to not facilitate, with a second tapered portion thereof, which is proximal to the support plate, a decoupling between the brake pad and the thrust device, where the retention device is in interference in an assembled configuration with the second tapered portion elastically biasing the thrust device against the brake pad along the thrust direction, where the retention device radially clamps the pin thus preventing rotations of the brake pad;

FIG. 5 shows a partially sectioned side view of the brake pad and thrust device assembly in FIG. 2, in which the brake pad, the pin, and the thrust device are sectioned with respect to a plane passing through a thrust device axis and a pin extension axis, preferably coincident to each other, so as to show the spring, preferably flush, housed in a groove of the thrust device which clamps the pin on the second tapered portion;

FIG. 6 is an axonometric view of a retention device of the brake pad and thrust device assembly according to an embodiment of the present invention, adapted to be housed in the thrust device cavity and constrained to the inner surface of the thrust device, as well as adapted to obtain a coupling seat for the pin to clamp the pin radially from diametrically opposite sides and retain the pin axially;

FIG. 7 shows a front view of the retention device, the thrust device, and the pin, taken along a section plane orthogonal to the thrust direction X-X;

FIG. 8 and FIG. 9 show, in a sectioned side view, an insertion sequence of the pin between the first retention arm and the second retention arm of the brake pad and thrust device assembly according to the present invention, in which the sliding enlargement of the two spring arms on the tapered surface of the first tapered portion of the pin up to reach a maximum portion of the pin can be seen, in which the radial clamping force is maximum and the axial insertion force is minimum;

FIG. 10 shows, in a sectioned side view, a nominal working condition of the brake pad engaged with the thrust device and/or a separation condition of the brake pad coupled by the thrust device, in which the pin can be seen between the first retention arm and the second retention arm of the brake pad and thrust device assembly according to the present invention, where the spring applies an axial force which opposes an extraction of the pin from the coupling seat formed by the two spring arms;

FIG. 11 shows a side view of a detail of the brake pad pin, in which the geometry of the pin coupling portion can be seen;

FIG. 12 is an axonometric view of a retention device of the brake pad and thrust device assembly according to an embodiment of the present invention, adapted to be housed in the thrust device cavity and constrained to the inner surface of the thrust device, as well as adapted to obtain a pin coupling seat for radially clamping the pin, from diametrically opposite sides, and axially retaining the pin, where the retaining device comprises at least one elbow-bent arm adapted to contact the pin and/or contrast the movements of the pin along at least two orthogonal directions Y-Y, Z-Z;

FIG. 13 shows a front view of the retention device in FIG. 12 of the thrust device and pin according to the present invention, sectioned along a section plane orthogonal to the thrust direction X-X.

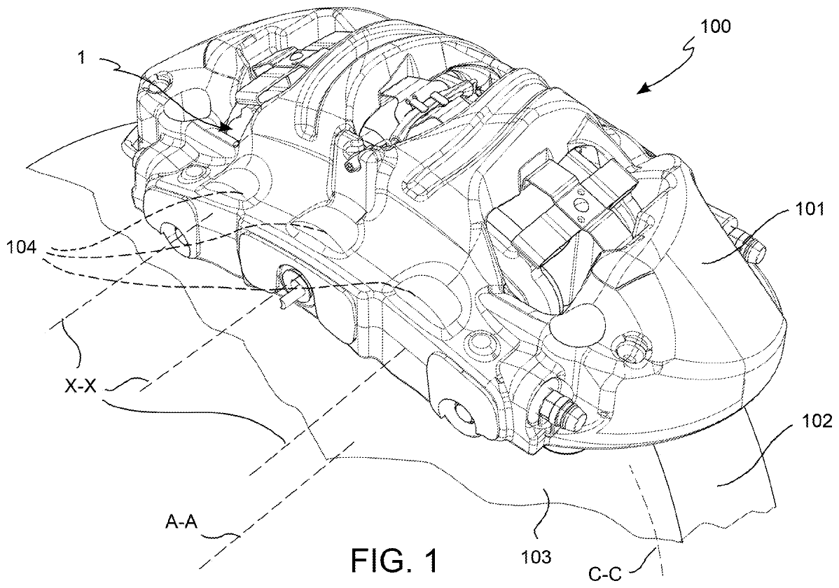

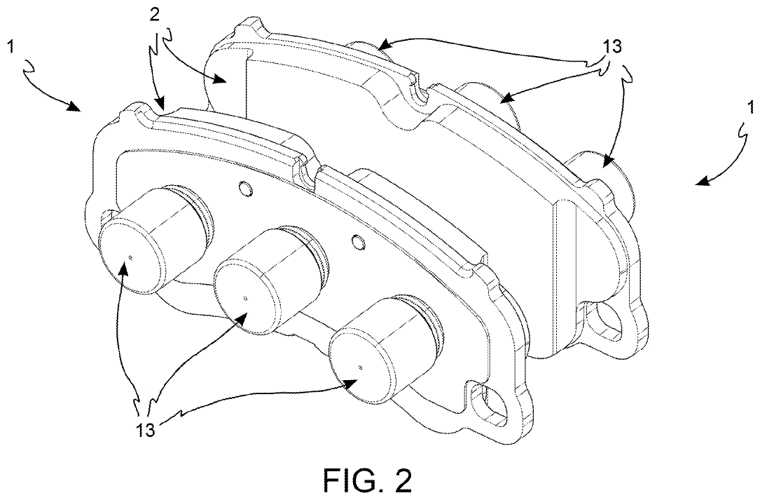

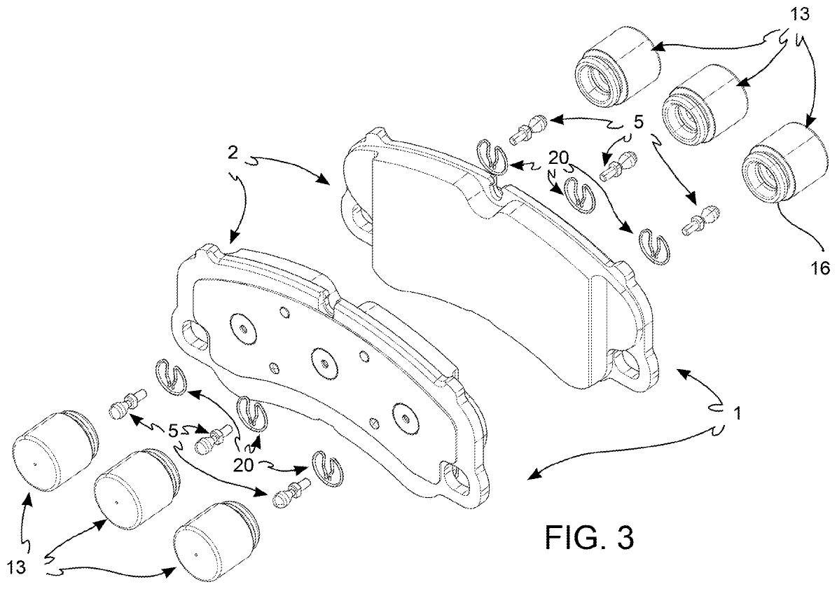

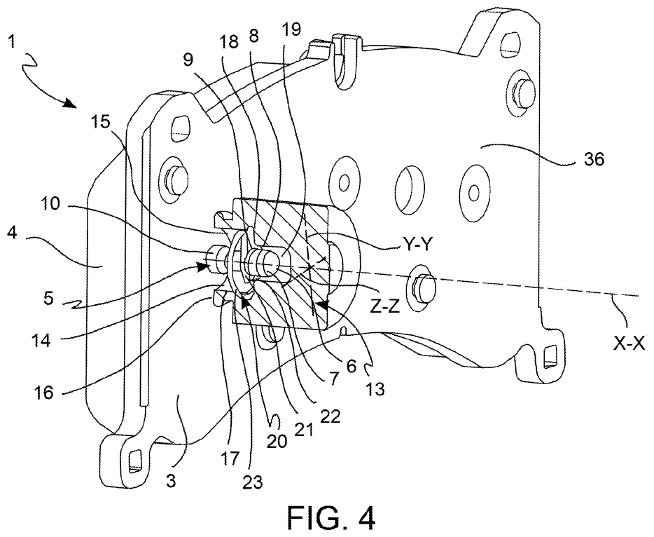

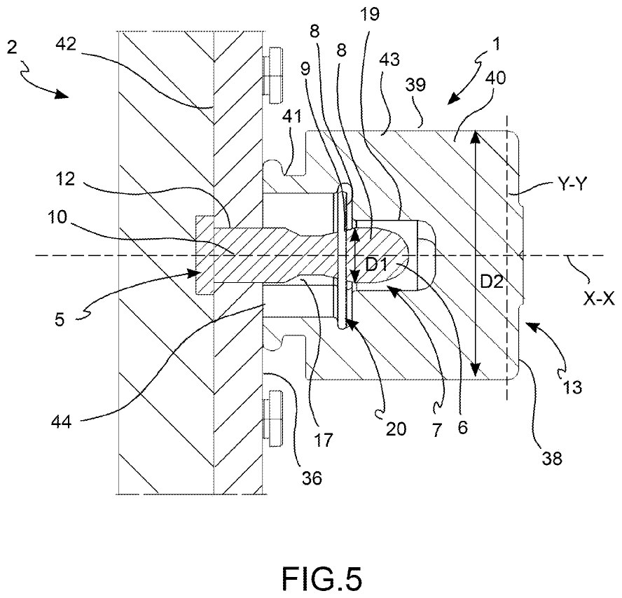

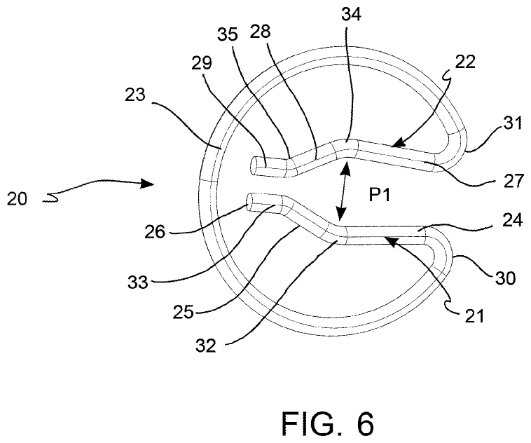

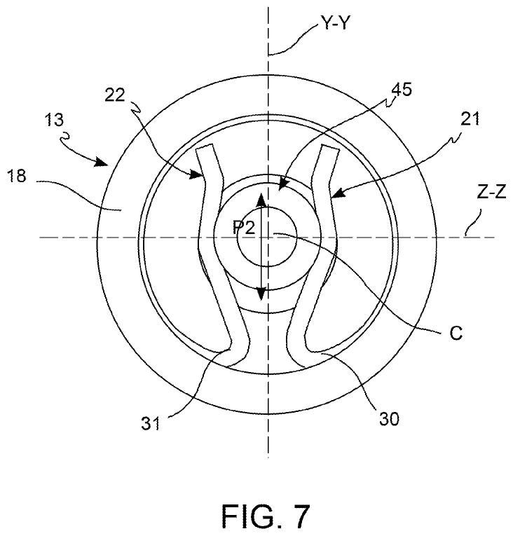

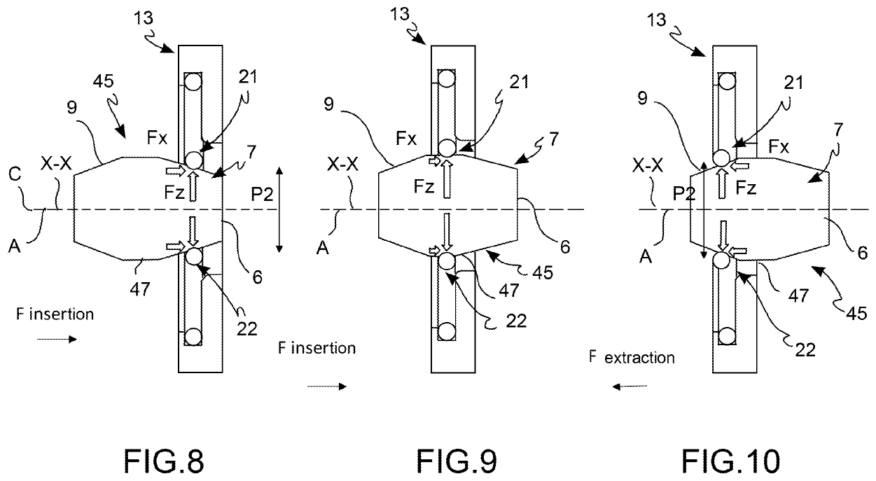

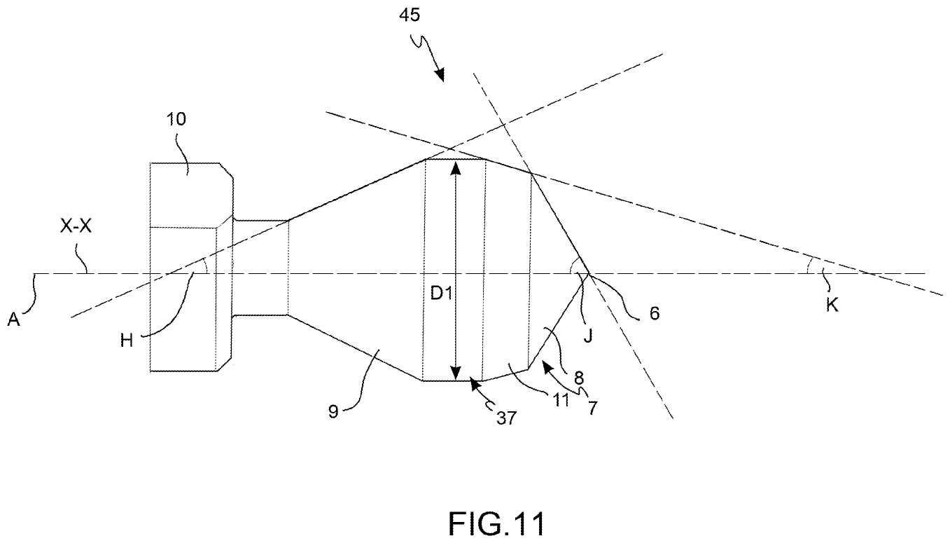

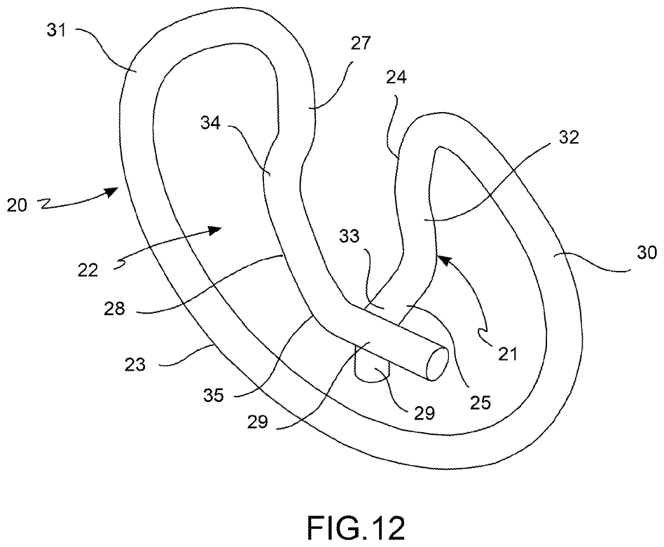

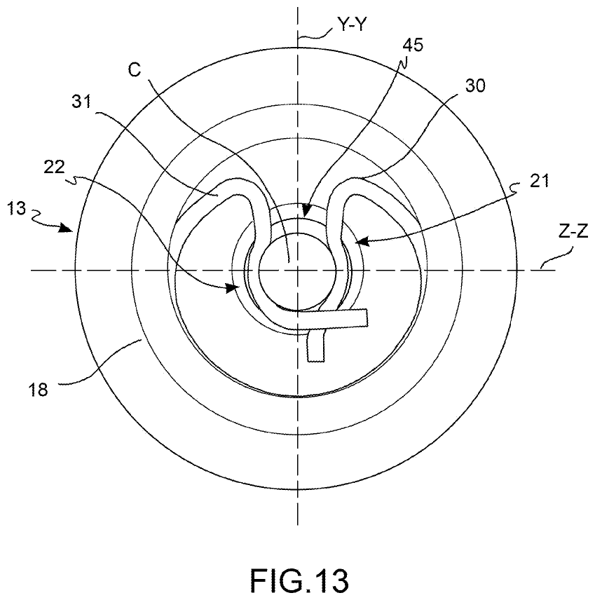

### DETAILED DESCRIPTION

According to a general embodiment, a brake pad and thrust device assembly for a brake caliper 100 is indicated by reference numeral 1.

The brake pad and thrust device assembly 1 comprises at least one brake pad 2 and at least one thrust device 13. Each thrust device 13 is reversibly connectable to the brake pad 2. Each thrust device 13 is adapted to bias said brake pad 2 along a thrust direction X-X resting against a braking surface 103 of a brake disc 102 to apply a braking action to a vehicle. Each thrust device 13 defining a radial Z-Z direction. The radial direction Z-Z is incident and/or perpendicular to said thrust direction X-X.

Said brake pad 2 comprises a friction material 4 adapted to abut against said braking surface 103 and apply said braking action.

Said brake pad 2 comprises a support plate 3 adapted to support said friction material 4 and receive a thrust from the thrust device 13. The support plate 3 comprises a support surface 42 adapted to face the friction material and support it, and a thrust surface 36 adapted to receive said thrust device 13 resting thereon.

Said brake pad 2 comprises at least one pin 5 extending along a pin extension axis A between a pin root 10 and a free pin end 6. Said at least one pin 5 is firmly fixed to the brake pad 2 protruding in a cantilever manner from the plate 3 on the side of said thrust surface 36.

Said at least one thrust device 13 comprises a thrust device body 43 which internally delimits, with an inner thrust device surface 15 extending about a thrust device axis C, a thrust device cavity 14 having at least one cavity opening 44 substantially facing said brake pad 2. The thrust device axis C is either parallel to or coincident with the thrust direction X-X.

Said brake pad and thrust device assembly 1 comprises at least one retention device 20. Said retention device 20 comprises at least one anchoring portion 23 adapted to constrain said retention element 20 to said inner thrust device surface 15. Said retention device 20 is housed in said thrust device cavity 14 and is constrained to said inner thrust device surface 15.

In an assembled configuration of said at least one brake pad 2 and said at least one thrust device 13, said at least one retention device 20 holds said pin 5 within said thrust device cavity 14 at least by applying an axial force Fx to said pin 5 along said thrust direction X-X or a direction parallel thereto by biasing said thrust device 13 to abut against said brake pad 2.

Advantageously, said at least one retention device 20 holds said pin 5 inside said thrust device cavity 14 by applying a radial force Fz towards said pin 5 along said radial direction Z-Z or a direction parallel thereto.

Advantageously, said retention device 20 comprises at least a first retention arm 21 and at least a second retention arm 22, which extend from said at least one anchoring portion 23 into said thrust device cavity 14. Said at least a first retention arm 21 and said at least a second retention arm 22 are elastically movable with respect to a resting configuration away from and towards said thrust device axis C.

Advantageously, said pin 5 comprises a coupling and insertion portion 45. Said coupling and insertion portion 45 comprises a first tapered portion 7 and a second tapered portion 9.

Said first tapered portion 7 comprises said free pin end 6 and is tapered in an opposite direction to said second tapered portion 9, so as to wedge said pin 5 between said first retention arm 21 and said second retention arm 22 with said first tapered portion 7 during the insertion of the pin 5 into the thrust device cavity 14 along said thrust direction X-X, and so as to elastically abut by interference said first retention arm 21 and said second retention arm 22 against said second tapered portion 9 in said assembled configuration by applying said radial restraining force Fz in the radial direction Z-Z towards said pin 5 and said axial restraining force Fx in the axial direction A-A by biasing said thrust device 13 to abut against said support plate 3, opposing the disassembly of the brake pad 2 from the thrust device 13.

According to an embodiment, the brake pad 2 defines a thrust plane on the side of said thrust surface 36, where said pin extension axis A is orthogonal to said thrust plane.

According to an embodiment, in said assembled configuration, said thrust device 13 is elastically biased by said at least one retention device 20 to abut against said brake pad 2, while keeping a front thrust device portion, e.g., an annular thrust portion 16, which is perpendicular to said thrust direction X-X, parallel to said thrust plane and abutting against said thrust plane. The brake pad is thus parallel to the thrust surface of the front thrust device portion, as well as to the braking surface of the disc, and by keeping the abutment contact between the thrust device and the brake pad, rotations of the brake pad with respect to the rotation axis of the brake disc are prevented. According to an embodiment, in said assembled configuration, the brake pad 2 is always in contact with the thrust device in normal use condition, allowing the brake pad to follow the backward movements of the thrust device, without losing the abutment contact.

According to an embodiment, said retention device 20 is constrained to said inner thrust device surface 15 so as to avoid exiting from said thrust device cavity 14 when said brake pad 2 and said at least one thrust device 13 are in an assembled configuration, e.g., by arranging the retention device 20 in a special seat which holds it geometrically inside said thrust device cavity.

According to an embodiment, said first retention arm 21 and said second retention arm 22 face each other forming an engagement seat for said pin 5 therebetween so as to interfere with said pin 5 between said first retention arm 21 and said second retention arm 22 during said insertion along said thrust direction X-X of said pin 5 into said coupling seat.

According to an embodiment, said first retention arm 21 and said second retention arm 22 extend from said at least one anchoring portion 23 into said thrust device cavity 14 along a respective retention arm extension direction which is transverse and/or incident to a direction parallel to said thrust direction X-X.

According to an embodiment, each retention arm extension direction is transverse and/or incident to a direction parallel to said thrust direction X-X and is transverse and/or incident to a direction parallel to said radial direction Z-Z. According to an embodiment, said thrust device 13 defines a tangential direction Y-Y, perpendicular to both said thrust direction X-X and said radial direction Z-Z. According to an embodiment, each retention arm extension direction is parallel to said tangential direction Y-Y.

According to an embodiment, said first tapered portion 7 is adapted to be inserted along said thrust direction X-X sliding between said first retention arm 21 and said second retention arm 22 moving them away from each other during the insertion of said pin 5 into said thrust device cavity 14.

According to an embodiment, said second tapered portion 9 is adapted to be slidingly inserted between said first retention arm 21 and said second retention arm 22 approaching each other during the insertion of said pin 5 into said thrust device cavity 14 until it abuts against said second tapered portion 9 in a coupling configuration by biasing the thrust device 13 to abut against the brake pad.

According to an embodiment, said coupling and insertion portion 45, going along said pin extension axis A from said free pin end 6 towards said pin root 10, comprises said first tapered portion 7 and said second tapered portion 9 in sequence.

According to an embodiment, said first tapered portion 7 and said second tapered portion 9 are adapted to be inserted between said first retention arm 21 and said second retention arm 22 at least partially sliding against said first retention arm 21 and said second retention arm 22 until said thrust device 13 abuts against said support plate 3 connecting said thrust device 13 to said brake pad 2 in said assembled configuration.

According to an embodiment, said first tapered portion 7, going along said pin extension axis A from said free pin end 6 towards said second tapered portion 9, widens in section away from said pin extension axis A, so as to wedge said pin 5 between said first retention arm 21 and said second retention arm 22 during said insertion.

According to an embodiment, said second tapered portion 9, going along said pin extension axis A from said first tapered portion 7 towards said pin root 10, narrows in section towards said pin extension axis A so that in said assembled configuration said first retention arm 21 and said second retention arm 22 apply said radial restraining force Fz towards said pin extension axis A and said axial restraining force Fx in said thrust direction X-X while keeping said thrust device 13 abutting against said support plate 3, opposing a disassembly of the brake pad 2 from the thrust device 13.

According to an embodiment, said first retention arm 21 and said second retention arm 22 are elastically movable towards and away from said pin extension axis A, e.g., along said radial direction Z-Z or a direction parallel thereto which is orthogonal and/or incident to said pin extension axis A, between a resting configuration and at least one interference configuration.

According to an embodiment, said first retention arm 21 and said second retention arm 22 are spaced apart by a resting distance P1.

According to an embodiment, in said at least one interference configuration, said first retention arm 21 and said second retention arm 22 are spaced apart by a clamping distance P2 and in contact with said coupling and insertion portion 45 of said pin 5.

According to an embodiment, said clamping distance P2 is greater than said resting distance P1.

According to an embodiment, said first retention arm 21 and said second retention arm 22 are constantly elastically biased towards said resting configuration.

According to an embodiment, said coupling and insertion portion 45 of said pin 5 has a coupling and insertion portion diameter D1, along said pin extension axis A. Said coupling and insertion portion diameter D1 varies along said pin extension axis A. Within this description, diameter means the maximum dimension of the pin and/or thrust device with respect to the respective extension axis.

According to an embodiment, said coupling and insertion portion diameter D1, measured at said free pin end n 6 is smaller than said resting distance P1 so as to wedge the free pin end 6 between said first retention arm 21 and said second retention arm 22 during said insertion.

According to an embodiment, said coupling and insertion portion diameter D1, at least in some positions, measured along said first tapered portion 7 and measured along said second tapered portion 9, is greater than said resting distance P1.

According to an embodiment, said clamping distance P2 is equal to said coupling and insertion portion diameter D1 along said first tapered portion 7 and along said second tapered portion 9 in the position in which said first retention arm 21 and said second retention arm 22 are in contact with said pin 5 elastically clamping it during said insertion and in said assembled configuration.

According to an embodiment, said first tapered portion 7 has, in at least one segment thereof, a second taper angle K with respect to said pin extension axis A.

According to an embodiment, said second tapered portion 9 has a third taper angle H with respect to said pin extension axis A.

According to an embodiment, said second taper angle K defines the driving load or insertion load, i.e., the load that must be overcome to connect the pin to the thrust device and/or the retaining device. According to an embodiment, said third taper angle H defines the load with which the thrust device is pressed against the pad by said retention device 20 and the extraction load of the pin from the thrust device and/or retention device. According to an embodiment, said third taper angle H is greater than said second taper angle K such that an insertion load or driving load, to insert said pin 5 sliding at least between the first retention arm 21 and the second retention arm 22 during said insertion to connect the thrust device 13 to the brake pad 2 until said thrust device 13 elastically abuts against the support plate 3 in said assembled configuration, is less than a maximum extraction load of the pin 5 clamped by said retention device 20 to separate said brake pad 2 from said thrust device.

According to an embodiment, said pin 5 comprises a plateau portion 37 between said first tapered portion 7 and said second tapered portion 9. According to an embodiment, the plateau portion 37 is the portion of said coupling and insertion portion 45 having the maximum diameter of said pin.

According to an embodiment, said plateau portion 37 is flat and parallel to said thrust direction X-X and/or said pin extension axis A.

According to an embodiment, said coupling and insertion portion 45 of said pin 5 extends with axial symmetry about said axial direction A-A.

According to an embodiment, said coupling and insertion portion 45 of said pin 5 has a symmetry plane parallel to said thrust direction X-X and/or said pin extension axis A.

According to an embodiment, said coupling and sliding portion 45 of said pin 5 extends with mirror symmetry with respect to said symmetry plane.

According to an embodiment, said first tapered portion 7 and said second tapered portion 9 are delimited by respective, at least partially conical surfaces.

According to an embodiment, said first tapered portion 7 and said second tapered portion 9 are seamlessly tapered, avoiding including grooves or stepped portions.

According to an embodiment, said first tapered portion 7 comprises, in sequence from said free pin end 6 towards said pin root 10, a first tapered part 8 and a second tapered part 11.

According to an embodiment, said first tapered part 8 has a first taper angle J with respect to said pin extension axis A.

According to an embodiment, said second tapered part 11 has a second taper angle K with respect to said pin extension axis A.

According to an embodiment, said first taper J is greater than said second taper angle K.

According to an embodiment, said third taper angle H is between said second taper angle K and said first taper angle J.

According to an embodiment, said coupling and sliding portion 45 of said pin 5 is devoid of annular grooves in which said first retention arm 21 and/or said second retention arm 22 could engage or abut as an undercut.

According to an embodiment, said retaining device 20 is a wire spring.

According to an embodiment, said anchoring portion 23 extends along a circular direction about said axial direction A-A between a first end and a second end.

According to an embodiment, said first retention arm 21 extends from said first end, and said second retention arm 22 extends from said second end.

According to an embodiment, said retention device 20 is bent in a plane perpendicular to said thrust direction X-X, forming an open loop with said anchoring portion 23 adapted to elastically interfere along said radial direction Z-Z or a direction parallel thereto against said inner thrust device surface 15.

According to an embodiment, said first retention arm 21 comprises a first segment 24 of first arm connected to said anchoring portion 23, a second segment 25 first arm connected to said first segment 24 of first arm, and a third segment 26 of first arm connected to said second segment 25 of first arm. According to an embodiment, said third segment 26 of first arm is connected to said second segment 25 of first arm forming a free first arm end.

According to an embodiment, said second retention arm 22 comprises a first segment 27 of second arm connected to said anchoring portion 23, a second segment 28 of second arm connected to said first segment 27 of second arm, and a third segment 29 of second arm connected to said second segment 28 of second arm. According to an embodiment, said third segment 29 of second arm is connected to said second segment 28 of second arm forming a free second arm end.

According to an embodiment, said first segment 24 of first arm, said second segment 25 of first arm, and said third segment 26 of first arm are straight segments connected together by curvilinear segments.

According to an embodiment, said first segment 27 of second arm, said second segment 28 of second arm, and said third segment 29 of second arm are straight segments connected together by curvilinear segments.

According to an embodiment, said first retention arm 21 is connected to said anchoring portion 23 by means of a first arm root 30.

According to an embodiment, the first arm root 30 is bent, preferably forming a bend of at least 90 degrees, with respect to the circular direction of the anchoring portion 23 by placing the first retention arm 21 in an inside position with respect to the circular direction of the anchoring portion 23. According to an embodiment, said first arm root 30 forms a first arm fulcrum about which the first retention arm 21 elastically rotates to and from said resting configuration.

According to an embodiment, said second retention arm 22 is connected to said anchoring portion 23 by means of a second arm root 31. According to an embodiment, said second arm root 31 is bent, preferably forming a bend of at least 90 degrees, with respect to the circular direction of the anchoring portion 23 by placing the second retention arm 22 in an inside position with respect to the circular direction of the anchoring portion 23. According to an embodiment, said second arm root 31 forms a second arm fulcrum about which the second retention arm 22 elastically rotates to and from said resting configuration.

According to an embodiment, in said resting configuration, said third segment 26 of first arm and said third segment 29 of second arm are parallel.

According to an embodiment, in said resting configuration and/or in said interference configuration, said third segment 26 of first arm and said third segment 29 of second arm are axially offset with respect to said thrust direction (X-X) or a direction parallel thereto, where said third segment 26 of first arm is transverse and/or incident to a direction parallel to the extension direction of said third segment 29 of second arm and vice versa.

According to an embodiment, in said resting configuration, said second segment 25 of first arm and said second segment 28 of second arm converge towards each other.

According to an embodiment, said first segment 24 of first arm is connected to said second segment 25 of first arm by means of a first bent segment 32 of first arm.

According to an embodiment, said second segment 25 of first arm is connected to said third segment 26 of first arm by means of a second bent segment 33 of first arm.

According to an embodiment, said first bent segment 32 of first arm is bent on the opposite side with respect to said second bent segment 33 of first arm, so that said first retention arm 21 is bent in an S-shape.

According to an embodiment, said first segment 27 of second arm is connected to said second segment 28 of second arm by means of a first bent segment 34 of second arm.

According to an embodiment, said second segment 28 of second arm is connected to said third segment 29 of second arm by means of a second bent segment 35 of second arm.

According to an embodiment, said first bent segment 34 of second arm is bent on the opposite side with respect to said second bent segment 35 of second arm, so that said second retention arm 22 is bent in an S-shape.

According to an embodiment, said first bent segment 34 of second arm is bent on the same side with respect to said second bent segment 35 of second arm, so that said second retention arm 22 is bent in a hook.

According to an embodiment, said first retention arm 21 and said second retention arm 22 are bent so that a portion of the second retention arm is transverse to a direction parallel to the extension direction of the first retention arm.

According to an embodiment, said retention second arm 22 is bent in a hook.

According to an embodiment, said first retention arm 21 and said second retention arm 22 are bent so as to overlap at least partially.

According to an embodiment, said first bent segment 32 of first arm and said first bent segment 34 of second arm are bent so as to accommodate and clamp the coupling and insertion portion 45 of said pin 5.

According to an embodiment, said first retention arm 21 and said second retention arm 22 are bent so as to accommodate and clamp the coupling and insertion portion 45 of said pin 5.

According to an embodiment, said thrust device 13 comprises an annular thrust device mouth 16, where said annular thrust device mouth 16 is configured to abut against the thrust surface 36, where said annular thrust device mouth 16 delimits the opening 44 of the thrust device cavity 14.

According to an embodiment, when said thrust device 13 and said brake pad 2 are in an assembled configuration, said retention device 20 applies said radial restraining force Fz in the radial direction Z-Z towards said pin 5 and said axial restraining force Fx in the thrust direction X-X, which keeps the annular thrust device mouth 16 abutting against the thrust surface 36, opposing a disassembly of the brake pad 2 from the thrust device 13, and keeping the support plate 3 parallel to the annular thrust device mouth 16.

According to an embodiment, said inner thrust device surface 15 defines a groove adapted to form an annular thrust device seat 18 to house said anchoring undercut portion 23 by constraining the retention device 20 within the thrust device cavity 14.

According to an embodiment, said annular thrust device seat 18 is delimited along a direction parallel to said thrust direction X-X by two circular crown walls spaced apart from each other to allow the insertion of said anchoring portion 23 by constraining it to said inner thrust device surface 15.

According to an embodiment, said thrust device cavity 14 comprises a first cavity portion 17 adapted to allow the insertion of the retention device 20, an annular thrust device seat 18 adapted to house the retention device 20, and a second cavity portion 19 adapted to house the first tapered portion 7 and the plateau portion 37 when said thrust device 13 and said brake pad 2 are in an assembled configuration with said annular thrust device mouth 16 abutting against said plate 3.

According to an embodiment, the thrust device cavity 14 along said axial direction A-A is open on the side of said brake pad 2 and is closed on the opposite side.

According to an embodiment, the thrust device 13 comprises a thrust device bottom 38 which constrains the thrust device 13 on the opposite side with respect to said annular thrust device mouth 16 and closes said thrust device cavity 14.

According to an embodiment, said thrust device bottom 38 is adapted to receive a hydraulic and/or mechanical thrust to bias the brake pad 2 against a brake disc 102.

According to an embodiment, said thrust device 13 has an outer side surface 39 which externally and/or radially delimits said thrust device 13 about said axial direction A-A.

According to an embodiment, said thrust device 13 has a thrust device diameter D2 measured along a thrust device extension axis parallel to the thrust direction X-X, where said thrust device diameter D2 is between 32 mm and 28 mm.

According to an embodiment, said thrust device 13 comprises an enlarged portion 40 and a narrowed portion 41 connected to each other in a stepped manner.

According to an embodiment, said enlarged portion 40 comprises said thrust device bottom 38, and said narrowed portion 41 comprises said annular thrust device mouth 16.

According to an embodiment, said pin 5 is made of stainless steel or galvanized steel. According to an embodiment, said retention device 20 is made of galvanized carbon steel or stainless steel. According to an embodiment, said pin 5 is screwed to the support plate 3. According to an embodiment, said pin 5 is welded to the support plate 3. According to an embodiment, said pin 5 is glued to the support plate 3.

According to an embodiment, said pin root 10 has an undercut portion with the support plate 3 on the side of the friction material 4. According to an embodiment, the pin root 10 is at least partially embedded in the friction material 4. According to an embodiment, said support plate 3 comprises a through seat 12 for each pin 5. According to an embodiment, said pin is coupled to the respective through seat 12. According to an embodiment, said pin is connected to the support plate by interference with respect to an edge of the respective through seat 12.

The present invention further relates to a brake caliper 100 comprising a caliper body 101 adapted to straddle a brake disc 102. The brake disc 2 is adapted to rotate about a rotation axis A-A which defines an axial direction A-A parallel to said thrust direction X-X. The brake disc 2 comprises a first braking surface 103 extending along a direction parallel to said radial direction Z-Z and along said tangential direction Y-Y, as well as along a circumferential direction C-C punctually perpendicular to said radial direction Z-Z and said tangential direction Y-Y or directions parallel thereto.

The brake caliper 100 comprises at least one brake pad and thrust device assembly 1 according to any one of the embodiments described above.

Said at least one thrust device 13 and the respective brake pad 2 are in an assembled configuration.

Each thrust device 13 is housed in a respective thrust device seat 104 made in the caliper body 101.

According to an embodiment, said brake caliper 100 comprises two brake pads 2 housed in said caliper body 101. According to an embodiment, each brake pad comprises three respective pins 5 firmly connected to the brake pad 2. According to an embodiment, said brake caliper 100 comprises two pairs of three thrust devices 13, where each thrust device 13 is connected by means of a respective retention device 20 to a respective pin 5 firmly connected to a respective brake pad 2.

The present invention further relates to a method for reversibly connecting a thrust device to a brake pad. Said method comprising the steps of:
providing a brake pad and thrust device assembly 1 according to any one of the embodiments described above, where said retention device 20 with said anchoring portion 23 is constrained to said inner thrust device surface 15, so that said first retention arm 21 and said second retention arm 22 are within said thrust device cavity 14, where said method for assembling said thrust device 13 to said brake pad 2 includes the steps of:
approaching said thrust device 13 along said thrust direction X-X from the side of said cavity opening 44 to said pin 5, or vice versa, by inserting said pin (5) into said thrust device cavity 14,
pushing said thrust device 13 along said thrust direction X-X towards said brake pad 2, or vice versa, by wedging in a first insertion step said pin 5 between said first retention arm 21 and said second retention arm 22 with said first tapered portion 7 and sliding in a second insertion step said second tapered portion 9 between said first retention arm 21 and said second retention arm 22 until said thrust device 13 abuts against said support plate 3, and until said first retention arm 21 and said second retention arm 22 elastically abut against said second tapered portion 9 in a coupling configuration by applying a radial restraining force Fz in a radial direction Z-Z towards said pin 5 and an axial restraining force Fx in an axial direction A-A which keeps said thrust device 13 abutting against said support plate 3;
and/or where said method for separating said thrust device 13 to said brake pad 2 includes the steps of:
pulling said thrust device 13 along said thrust direction X-X away from said brake pad 2, or vice versa, by wedging in a first extraction step said pin 5 between said first retention arm 21 and said second retention arm 22 with said second tapered portion 9 overcoming said restraining force Fx and sliding in a second extraction step said first tapered portion 7 between said first retention arm 21 and said second retention arm 22 until said first retention arm 21 and said second retention arm 22 are in said resting configuration.

### LIST OF REFERENCE SIGNS

47 brake pad and thrust device assembly
48 brake pad
49 support plate
50 friction material
51 pin
52 free pin end
53 first tapered portion
54 first tapered part
55 second tapered portion
56 pin root
57 second tapered part
58 pin through seat
59 thrust device or piston
60 thrust device cavity
61 inner thrust device surface
62 annular thrust device mouth
63 first cavity portion
64 annular thrust device seat
65 second cavity portion
66 retention device
67 first retention arm
68 second retention arm
69 anchoring portion
70 first segment of first arm
71 second segment of first arm
72 third segment of first arm
73 first segment of second arm
74 second segment of second arm
75 third segment of second arm
76 first arm root
77 second arm root
78 first bent segment of first arm
79 second bent segment of first arm
80 first bent segment of second arm
81 second bent segment of second arm
82 thrust surface
83 plateau portion
84 thrust device bottom
85 outer side surface of thrust device
86 enlarged portion
87 narrowed portion
88 support surface
89 thrust device body
90 cavity opening
91 coupling and insertion portion
92 third retention arm
100 brake caliper
101 caliper body
102 brake disc
103 braking surface
104 thrust device or cylinder seat
P1 Resting distance
P2 Clamping distance
D1 Coupling and insertion portion diameter
D2 Thrust device diameter
A Pin extension axis
C Thrust device axis

What is claimed is:

1-12. (canceled)

13. A brake pad and thrust device assembly for a brake caliper, comprising at least one brake pad and at least one thrust device, wherein said at least one thrust device is reversibly connectable to the brake pad, wherein said at least one thrust device is adapted to bias said brake pad along a thrust direction resting against a braking surface of a brake disc to apply a braking action to a vehicle, said at least one thrust device defining a radial direction, wherein said radial direction is incident and/or perpendicular to said thrust direction,
said brake pad comprising:
a friction material adapted to abut against said braking surface and apply said braking action,
a support plate adapted to support said friction material and receive a thrust of said at least one thrust device, wherein the support plate comprises a support surface adapted to face the friction material and support it, and a thrust surface adapted to receive said at least one thrust device resting thereon,
at least one pin extending along a pin extension axis between a pin root and a free pin end, wherein each pin is firmly fixed to the brake pad by protruding in a cantilevered manner from the plate on the side of said thrust surface, wherein said at least one thrust device comprises a thrust device body internally delimiting, with an inner thrust device surface extending about a thrust device axis either parallel to or coincident with said thrust direction, a thrust device cavity having at least one cavity opening substantially facing said brake pad,
wherein said brake pad and thrust device assembly comprises at least one retention device,
wherein said retention device comprises at least one anchoring portion adapted to constrain said retention element to said inner thrust device surface,
wherein said retention device is housed in said thrust device cavity and is constrained to said inner thrust device surface,
wherein, in an assembled configuration of said at least one pad and said at least one thrust device, said at least one retention device holds said pin within said thrust device cavity at least by applying an axial force to said pin along said thrust direction or a direction parallel thereto by biasing said thrust device into abutment against said brake pad,
wherein said at least one retention device holds said pin within said thrust device cavity by applying a radial force towards said pin along said radial direction or a direction parallel thereto so as to prevent said brake pad from sliding,
wherein said retention device comprises at least a first retention arm and at least a second retention arm, which extend from said at least one anchoring portion into said thrust device cavity,
wherein said at least a first retention arm and said at least a second retention arm are elastically movable with respect to a resting configuration away from and towards said thrust device axis,
wherein each pin comprises a coupling and insertion portion,
wherein said coupling and insertion portion comprises a first tapered portion and a second tapered portion,
wherein said first tapered portion comprises said free pin end, wherein said first tapered portion is tapered in an opposite direction to said second tapered portion, so as to wedge said pin between said at least a first retention arm and said at least a second retention arm with said first tapered portion during the insertion of the pin into the cavity of the thrust device along said thrust direction,
and so as to elastically abut said at least a first retention arm and said at least a second retention arm against said second tapered portion in said assembled configuration by applying said radial restraining force in the radial direction towards said pin and said axial restraining force in the axial direction by biasing said thrust device into abutment against said support plate, opposing the disassembly of the brake pad from the thrust device.

14. The brake pad and thrust device assembly according to claim 13, wherein said coupling and insertion portion, going along said pin extension axis from said free pin end towards said pin root, comprises said first tapered portion and said second tapered portion in sequence,
wherein said first tapered portion and said second tapered portion are adapted to be inserted between said first retention arm and said second retention arm at least partially sliding against said first retention arm and said second retention arm until said thrust device abuts against said support plate to connect said thrust device to said brake pad in said assembled configuration,
wherein said first tapered portion, going along said pin extension axis from said free pin end towards said second tapered portion, widens in section away from said pin extension axis, so as to wedge said pin between said first retention arm and said second retention arm during said insertion,
wherein said second tapered portion, going along said pin extension axis from said first tapered portion towards said pin root, narrows in section towards said pin extension axis so that in said assembled configuration said first retention arm and said second retention arm apply said radial
restraining force towards said pin extension axis and said axial restraining force in said thrust direction while keeping said thrust device abutting against said support plate, opposing a disassembly of the brake pad from the thrust device.

15. The brake pad and thrust device assembly according to claim 13, wherein said first retention arm and said second retention arm are elastically movable towards and away from said pin extension axis, along said radial direction or a direction parallel thereto which is orthogonal and/or incident to said pin extension axis, between said resting configuration and at least one interference configuration,
wherein in said resting configuration, said first retention arm and said second retention arm are spaced apart by a resting distance, and
wherein in said at least one interference configuration, said first retention arm and said second retention arm are spaced apart by a clamping distance in contact with said coupling and insertion portion of said pin,
wherein said clamping distance is greater than said resting distance,
wherein said first retention arm and said second retention arm is constantly elastically biased towards said resting configuration.

16. The brake pad and thrust device assembly according to claim 15, wherein said coupling and insertion portion of said pin has a coupling and insertion portion diameter,
wherein said coupling and insertion portion diameter at said free pin end is less than said resting distance so as to wedge the free pin end between said first retention arm and said second retention arm during said insertion, and
wherein said coupling portion diameter at least partially along said first tapered portion and along said second tapered portion is greater than said resting distance, and
wherein said clamping distance is equal to said coupling and insertion portion diameter along said first tapered portion and along said second tapered portion when said first retention arm and said second retention arm are in contact with said pin by elastically clamping it during said insertion and in said assembled configuration.

17. The brake pad and thrust device assembly according to claim 13, further comprising one or more of the following features:
wherein said first tapered portion has, in at least one segment thereof, a second taper angle with respect to said pin extension axis, wherein said second tapered portion has a third taper angle (H) with respect to said pin extension axis, wherein said third taper angle is greater than said second taper angle so that an insertion load to be overcome to slidingly insert said pin between the first retention arm and the second retention arm during said insertion to connect the thrust device to the brake pad until said thrust device elastically abuts against the support plate in said assembled configuration, is
less than an extraction load to be overcome to extract the pin clamped by said retention device separating said brake pad from said thrust device, and/or
wherein said pin comprises a plateau portion between said first tapered portion and said second tapered portion,
wherein said plateau portion is flat and parallel to said thrust direction and/or to said pin extension axis, and/or
wherein said coupling and insertion portion of said pin extends with axial symmetry about said axial direction, or
wherein said coupling and insertion portion of said pin has a symmetry plane parallel to said thrust direction and/or to said pin extension axis,
wherein said coupling and sliding portion of said pin extends with mirror symmetry with respect to said symmetry plane, and/or
wherein said first tapered portion and said second tapered portion are delimited by respective at least partially conical surfaces.

18. The brake pad and thrust device assembly according to claim 17, wherein said first tapered portion comprises, in sequence from said free pin end towards said pin root, a first tapered part and a second tapered part,
wherein said first tapered part has a first taper angle with respect to said pin extension axis,
wherein said second tapered part has said second taper angle with respect to said pin extension axis,
wherein said first taper angle is greater than said second taper angle, and/or
wherein said third taper angle is between said second taper angle and said first taper angle.

19. The brake pad and thrust device assembly according to claim 13, further comprising one or more of the following features:
wherein said retention device is a wire spring, and/or
wherein said anchoring portion extends along a circular direction about said axial direction between a first end and a second end, wherein said first retention arm extends from said first end and said second retention arm extends from said second end, and/or
wherein said retention device is bent in a plane transverse to said thrust direction, forming an open loop with said anchoring portion adapted to elastically interfere along said radial direction or a direction parallel thereto against said inner thrust device surface, and/or
wherein said first retention arm and said second retention arm are bent so as to accommodate and clamp the coupling and insertion portion of said pin, and/or
wherein said first retention arm and said second retention arm are bent so that a portion of the second retention arm is transverse to a direction parallel to the extension direction of the first retention arm, and/or
wherein said retention second arm is bent in a hook, and/or
wherein said first retention arm and said second retention arm are bent so as to at least partially overlap.

20. The brake pad and thrust device assembly according to claim 13, wherein said thrust device comprises an annular thrust device mouth, wherein said annular thrust device mouth is configured to abut against the thrust surface, wherein said annular thrust device mouth delimits the cavity opening of thrust device;
wherein when said thrust device and said brake pad are in an assembled configuration, said retention device applies said radial restraining force in the radial direction towards said pin and said axial restraining force in the thrust direction which keeps the annular thrust device mouth abutting against the thrust surface, opposing a disassembly of the brake pad from the thrust device, and keeping the support plate parallel to the thrust device annular mouth.

21. The brake pad and thrust device assembly according to claim 13, wherein said inner thrust device surface defines a groove adapted to form an annular thrust device seat to house said undercut anchoring portion, wherein said annular thrust device seat is delimited along a direction parallel to said thrust direction by two circular crown walls spaced apart from each other to allow the insertion of said anchoring portion by constraining it to said inner thrust device surface, and/or
wherein said thrust device cavity comprises a first cavity portion adapted to allow the insertion of the retention device, an annular thrust device seat adapted to house the retention device, and a second cavity portion adapted to house the first tapered portion and the plateau portion when said thrust device and said brake pad are in an assembled configuration with said annular thrust device mouth abutting against said plate; and/or
wherein said thrust device has a thrust device diameter, wherein said thrust device diameter is less than 34 mm, preferably said thrust device diameter is between 28 mm and 34 mm.

22. The brake caliper comprising the caliper body adapted to straddle the brake disc, and the at least one brake pad and thrust device assembly according to claim 13,
wherein each thrust device and the respective brake pad are in an assembled configuration,
wherein each thrust device is housed in a respective thrust device seat made in the caliper body.

23. A method for reversibly connecting the thrust device to the brake pad, comprising the steps of:
providing a brake pad and thrust device assembly according to claim 13, wherein said retention device with said anchoring portion is constrained to said inner thrust device surface, so that said first retention arm and said second retention arm are within said thrust device cavity, wherein said method for assembling said thrust device to said brake pad includes the steps of:
approaching said thrust device along said thrust direction from the side of said cavity opening to said pin, or vice versa, by inserting said pin into said thrust device cavity,
pushing said thrust device along said thrust direction towards said brake pad, or vice versa, by wedging in a first insertion step said pin between said first retention arm and said second retention arm, with said first tapered portion, and sliding in a second insertion step said second tapered portion between said first retention arm and said second retention arm until said thrust device abuts against said support plate, and until said first retention arm and said second retention arm elastically abut against said second tapered portion in a coupling configuration by applying a radial restraining force in a radial direction towards said pin and an axial restraining force in the axial direction which keeps said thrust device abutting against said support plate.

24. The method according to claim 23, wherein for separating said thrust device from said brake pad, said method comprises the steps of:
pulling said thrust device along said thrust direction away from said brake pad, or vice versa, by wedging in a first extraction step said pin between said first retention arm and said second retention arm with said second tapered portion overcoming said restraining force, and sliding in a second
extraction step said first tapered portion between said first retention arm and said second retention arm until said first retaining arm and said second retention arm are in said resting configuration.
